(19) United States
(12) Patent Application Publication
(10) Pub. No.: US 2016/0113224 A1
(43) Pub. Date: Apr. 28, 2016

(54) LARGE-SCALE ALGAE CULTIVATION SYSTEM WITH DIFFUSED ACRYLIC RODS AND DOUBLE PARABOLIC TROUGH MIRROR SYSTEMS

(71) Applicant: Morgan Hill Bioenergy, Inc., Morgan Hill, CA (US)

(72) Inventors: David Shiao-tsing Chiang, Pleasanton, CA (US); Xuezhi Zhang, Gilbert, AZ (US); Jun Wang, Morgan Hill, CA (US)

(73) Assignee: MORGAN HILL BIOENERGY, INC., Morgan Hill, CA (US)

(21) Appl. No.: 14/523,771

(22) Filed: Oct. 24, 2014

(51) Int. Cl. A01G 33/00; A01G 1/00; G02B 6/32; G02B 5/20; G02B 6/04; A01G 7/04; G02B 19/00

(52) U.S. Cl. CPC A01G 33/00; A01G 7/045; A01G 1/001; G02B 19/0023; G02B 19/0042; G02B 5/208; G02B 6/04; G02B 6/32

(57) ABSTRACT

The present disclosure provides a photobioreactor system designed for optimal algae productivity at large volumes in order to deliver a high yield per acre. The photobioreactor system comprises photobioreactor units, that may be isolated from each other to reduce culture clashes; an array of diffused acrylic rods attached to the bottom of a removable acrylic circular top in each photobioreactor unit that provides more light into the photobioreactors; a double parabolic trough mirror system, which utilizes two parabolic trough mirrors to reflect and concentrate sunlight into fiber optic cables; and an algae-cycling system mounted at the bottom of each photobioreactor unit and driven by air to circulate the algae suspension in a vertical motion.

### TECHNICAL FIELD

The present invention relates generally to algae cultivation systems and methods, and more particularly to deep containers utilizing arrays of diffused acrylic rods, algae-cycling systems, and sunlight collectors to build up a large-scale algae cultivation system.

### BACKGROUND OF THE INVENTION

Algae have gained significant attention in recent years given its advantage in solving several critical global issues such as the production of renewable fuels and animal feedstock, reducing global climate change via carbon dioxide remediation, wastewater treatment, and sustainability. Algae oil can be converted into biodiesel, green diesel, bio-jet and chemicals. The residual biomass, which is high in proteins and carbohydrates, can be used in aquaculture, animal feed, food, and feed ingredients. Algae's superior characteristics such as high per-acre productivity, as compared to other oil crop plants, make it a better alternative feedstock to replace the traditional fuel and to be cultivated on non-productive, non-arable land.

There are many different approaches to growing algae. Typically photobioreactors, such as flat panel photobioreactors or tubular photobioreactors, are used and need to be small in volume in order to gain more light for algae. These devices are lower in volume and higher in cost, which prevent scale-up production. Also, many of them have temperature control issues during the summer. Other photobioreactor systems, such as ponds or raceways, are used to provide larger scale production, but these systems suffer from low productivity and higher risk of culture crashes, which decreases the productivity and are not good for food or animal feed. Pond systems also require paddle wheels in its production, which requires large amounts of energy and reduces overall cost efficiency.

In algae cultivation, one of the most important elements is light. Light is always a limiting factor for algae growth. In order to increase the growth rate, photobioreactors with higher surface-to-volume ratio were designed with different shapes and configurations, such as panel, tubular, column etc. Higher algal growth can be achieved in these photobioreactors than in open ponds as a result of better light utilization. However, as light can only penetrate a short distance in algal culture, there are still dark areas or dark volume in these photobioreactors where no light or less light is received. The presence of dark volume limits the further increase of algal growth. Increasing light intensity improves light penetration and thus reduces the dark volume in the photobioreactors, and usually enhances growth. However, the increased energy consumption associated with increased intensity of artificial light is huge; and when sunlight is used, this light intensity increase is usually limited. Other solutions to increase light utilization have been reported, such as adding LED or optical fiber into the algal cultivation devices. However, as an artificial light source, LED cannot help utilize sunlight in algal cultivation or provide enough density of light. And in the case of an optical fiber solution, the light received cannot be distributed efficiently.

An advantageous method to transporting light into a photobioreactor system is via light guides that can transmit light deep into the system. Light guides are typically made from normal acrylic rods. In order to make light emitted from the side face of the rod, the rod ends and/or sides are buffed or frosted so that light is reflected off the rough surface, resulting in a increase of the light area surrounding the rod. Without the buffering or frosting, the basic characteristic of acrylic acts like a light tunnel. However, the buffed or frosted surface may not work in a clear liquid medium such as water in a photobioreactor system because water can change the frosted surface to be a non-reflective surface.

In order to increase the light intensity received by the photobioreactor, solar concentrators may be used to collect sunlight from a large area and concentrate the sunlight into a smaller area. It has been known that, unlike circular dishes, one or more parabolic dishes may be used to concentrate light onto a single focal point. This would be useful to provide enough light into a single fiber optic cable however with multiple photobioreactors and multiple fiber optic cables, it would be inefficient to use a single concentrator for each fiber optic cable in each photobioreactor unit. Thus, this invention provides a novel solution in which a parabolic trough mirror system, using two parabolic trough reflectors, is able to concentration light for more than 80 fiber optic cables and 80 diffused light rods at once.

### SUMMARY

The present disclosure provides a photobioreactor system designed for optimal algae productivity at large volumes in order to deliver a high yield per acre. Each photobioreactor unit may be closed and isolated from each other completely, which reduces culture crashes. With larger volume photobioreactors, algae-circulating systems may be used to improve temperature control of the algae suspension in a hot environment.

In a single photobioreactor unit, a cylindrical container is furnished with a removable acrylic circular top, which provides light for algae cultivation. An array of diffused acrylic rods are attached to the bottom of the removable acrylic circular top with strategic placement. Once the removable acrylic circular top sits on top of the cylindrical containder, the array of diffused acrylic rods may be placed inside an algae suspension to improve light utilization, reducing dark volume in the photobioreactor unit. The light received by the diffused acrylic rods will be delivered through a double parabolic trough mirror system, which utilizes two parabolic trough mirrors to reflect and concentrate sunlight into fiber optic cables. High density light is transferred through the fiber optic cables to the diffused acrylic rods and illuminating the algae suspension inside the photobioreactor unit. An algae-cycling system is mounted at the bottom of the cylindrical container and driven by air to circulate the algae suspension in a vertical motion. The conical bottom of the container helps the cycling and allows the algae suspension to completely leave the container at the bottom once it is ready to harvest and the cycling has paused.

Different light intensity and light distribution patterns can be provided by using rods with different densities and lengths, and/or using different array configurations. Because light can be delivered through the rods, algae cultivation does not have to be limited to shallow water. The deeper light can go, the larger areal ratio can be achieved. This will be significant in order to reduce land usage for algae cultivation. By placing the rods strategically, this invention can be used in any algal cultivation system, such as open ponds or photobioreactors, delivering and distributing both sunlight and even artificial light to increase light utilization, and algal growth.

These and other advantages and benefits of the present invention will be apparent from the Detailed Description herein below.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is an exploded perspective view of a photobioreactor unit according to a preferred embodiment of the invention.

FIG. 2 is a top view of a photobioreactor unit of FIG. 1 according to a preferred embodiment of the invention.

FIG. 3 is an exemplary illustration of a light ray tracing model for a preferred embodiment of a double parabolic trough mirror system and a single cylindrical acrylic rod.

FIG. 4 is a cross-sectional view of a preferred embodiment of a double parabolic trough mirror system of FIG. 3 taken along the broken line 4-4 shown in FIG. 3.

FIG. 5 is a schematic view of a photobioreactor system comprising two or more photobioreactor units and connecting plastic pipe and valves according to a preferred embodiment of the invention.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

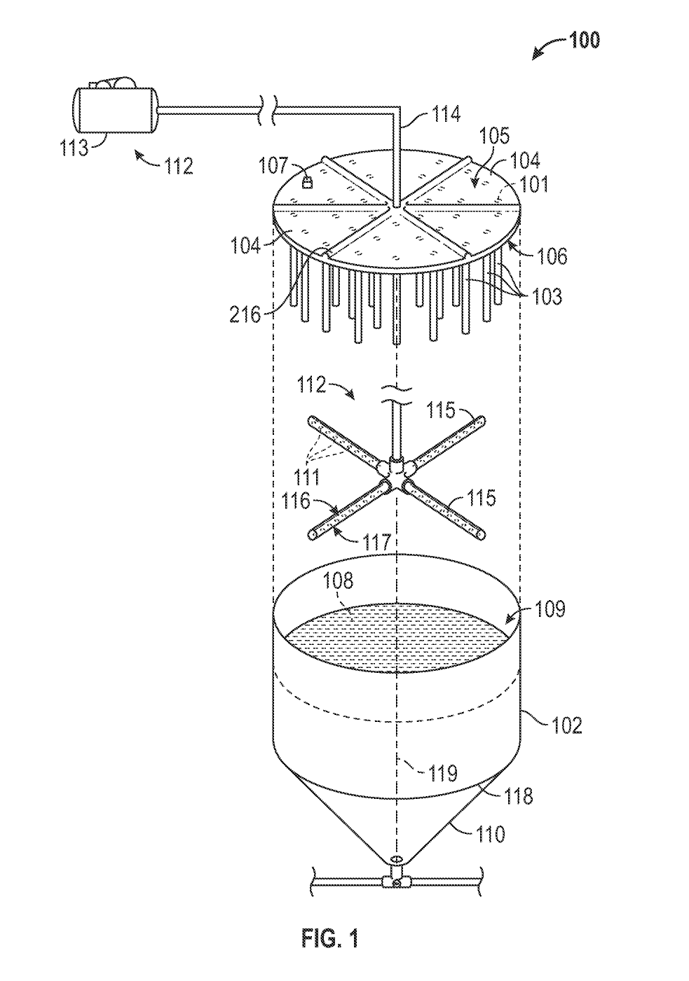

FIG. 1 shows an exploded view of an exemplary photobioreactor unit 100. In the preferred embodiment, the photobioreactor unit 100 comprises a container 102, a removable clear circular top 104 that has a top side 105 and a bottom side 106, and an array of diffused acrylic rods 103, hereinafter designated as rods, that are perpendicularly mounted to the bottom side 106 of the removable clear circular top 104 and allows light to penetrate through an algae suspension 108. In the preferred embodiment, to support the weight of the rods 103, across the top sides 105 of the removeable clear circular top 104 are clear support bars 216. The container 102 is preferably cylindrical along a vertical central axis 119 and has a conical bottom 110 closing the cylinder 102 and a circular opening 109 for receiving the removable clear circular top 104. The removable clear circular top 104 may be fastened to a flange around the circular opening 109 of the container 102 with bolts, while providing light for the algae suspension 108 and air tight sealing. In the preferred embodiment, the most optimal distance between the rods 103 is about 5 to 6 inches to provide optimal light coverage.

The container 102 also houses an algae-cycling system 112. The algae-cycling system 112 comprises a compressor 113 that provide pressure air into a main plastic pipe 114; the main plastic pipe 114, which connects to the removable clear circular top 104 and then is housed along the vertical center axis 119 of the container 102; and two or more branch plastic pipes 115 connecting perpendicularly to the main plastic pipe 114 and horizontally housed in the container 102. The two or more branch plastic pipes 115 are seated generally at the edge 118 of the conical bottom 110 of the container 102. All of the two or more branch plastic pipes 115 each have a top side 116 and a bottom side 117. On the bottom side 117 of the two or more branch plastic pipes 115 are a plurality of holes 111 where pressure air enters into the container 102 and vertically drives the circulation of the algae suspension 108 within the entire container 102 due to the shape of the conical bottom 110. CO2 may be mixed with pressured air and facilitates algae growth for the algae suspension 108.

In other embodiments, algae seeding and nutrients can be pumped into tank through a hole 101 on the removable circular top 104. Sensors 107 for monitoring algae cultivation may also be mounted on the removable circular top 104 to provide algae growth data.

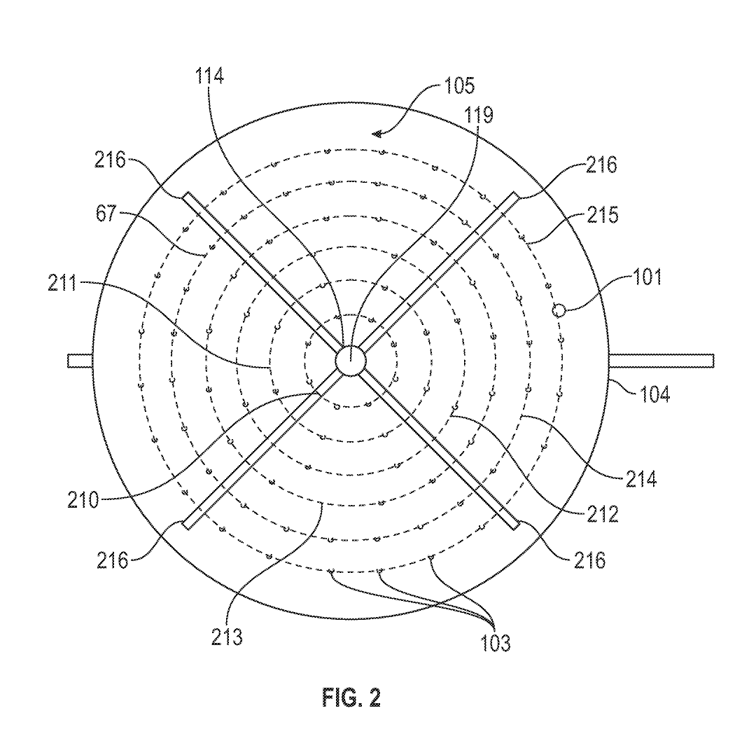

FIG. 2 shows the preferred embodiment of the placement of the rods 103. In the preferred embodiment, the container is 90 inches in diameter and 45 or 70 inches in height. Within the container 102, there are eight evenly spaced rods 103 along an imaginary first circle 210 having a diameter of 18 inches, sharing the same vertical center axis 119 as the container 102; eight evenly spaced rods 103 along an imaginary second circle 211 having a diameter of 30 inches, sharing the same vertical center axis 119 as the container 102; eight evenly spaced rods 103 along an imaginary third circle 212 having a diameter of 42 inches, sharing the same vertical center axis 119 as the container 102; sixteen evenly spaced rods 103 along an imaginary fourth circle 213 having a diameter of 54 inches, sharing the same vertical center axis 119 as the container 102; twenty-four evenly spaced rods 103 along an imaginary fifth circle 214 having a diameter of 66 inches, sharing the same vertical center axis 119 as the container 102; twenty-four evenly spaced rods 103 along an imaginary sixth circle 215 having a diameter of 80 inches, sharing the same vertical center axis 119 as the container 102. Thus, the preferred embodiment of the placement of the rods 103 results in a total of 88 rods 103.

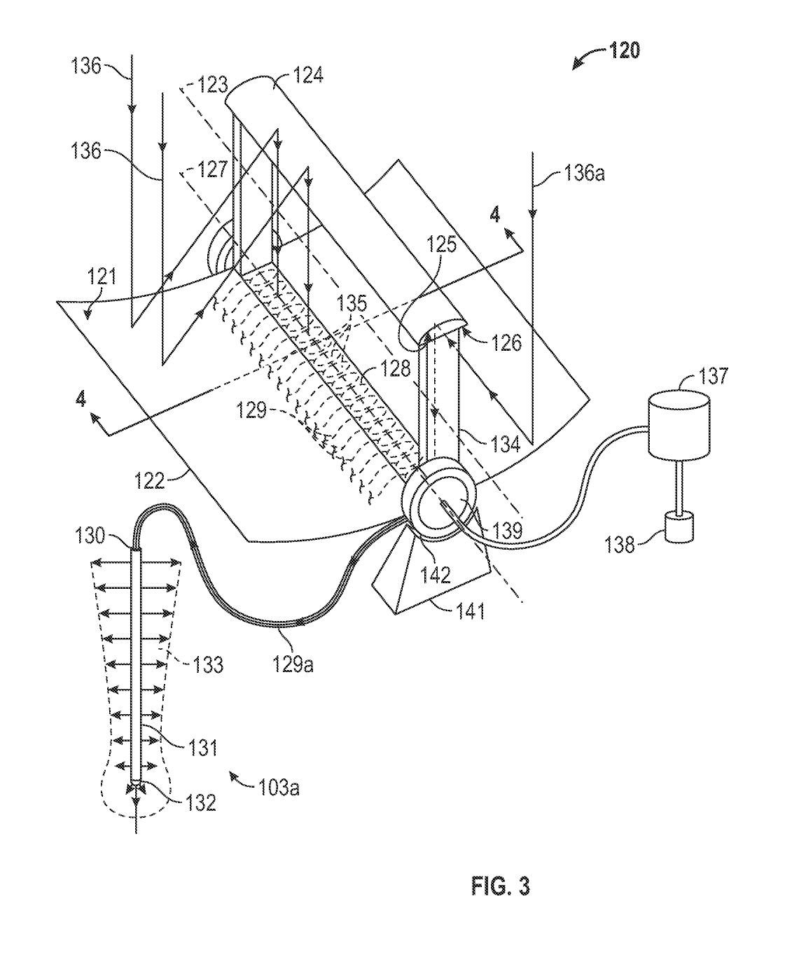

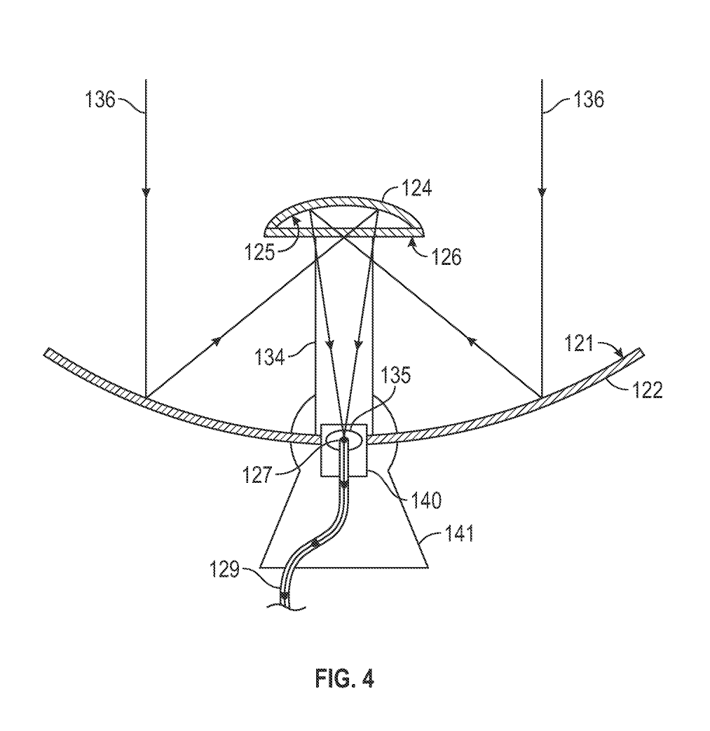

FIG. 3 shows the detail of a double parabolic trough mirror system 120 used to collect sunlight in order to provide sufficient light to the photobioreactor unit 100 (FIG. 1). The double parabolic trough mirror system 120 comprises a primary parabolic trough 122 with a reflective side 121 that faces its parabolic focal line 123, a secondary parabolic trough 124 with a reflective side 125 that also faces the parabolic focal line 123 of the primary parabolic trough 122. The reflective side 121 of the primary parabolic trough 122 is facing primarily upward towards the sun. In relation to the primary parabolic trough 122, the secondary parabolic trough 124 is held in place farther than the focal line 123 of the primary parabolic trough 122 by mounting racks 134 such that all sun rays 136 hitting the primary parabolic trough 122 would be reflected onto the secondary parabolic trough 124. The primary parabolic trough 122 has a vertex line 127 and a slit 128 at the vertex line 127 that is less than the dimensions of the secondary parabolic trough 124. The vertex line 127 also happens to be the secondary parabolic trough's 124 focal line. Adjacent right below the secondary parabolic trough 124 is an optic filter 126 that only allows wavelengths between 400 nm to 750 nm to be passed, as best seen in FIG. 4. The purpose of the optic filter 126 is to reduce the temperature of the sun rays 136 to the secondary parabolic trough 124. The sun rays 136 reflect twice, first off the primary parabolic trough 122 and then through the optic filter 126 and off the secondary parabolic trough 124, then through the slit 128 of the primary parabolic trough 122, as best seen in FIG. 4.

Referring to FIG. 3, a series fiber optic cables 129 below the slit 128 of the primary parabolic trough 122 receives the sun rays 136. The series of fiber optic cables 129, each of the series of fiber optic cables 129 with a core diameter of 19 mm, respectively connect to the rods 103. The sun rays 136 are transferred through the series of fiber optic cables 129 then through the rods 103. For example, a single fiber optic cable 129a transfers light to a single diffused acrylic rod 103a, hereinafter designates as a single rod. A series of lenses 135 sits on top of the series of fiber optic cables 129 respectively with a one-to-one ratio, in a holder 140 and converts a focused light into a 19 mm parallel light in order to reduce light loss.

A sunlight tracking sensor 138 follows the sun's movement and signals a solar tracking controller 137 that drives a motor 139 which sits on a base 141 that holds the entire double parabolic trough mirror system 120, and steers the double parabolic trough mirror system 120 in the director of the sun, such that sun rays 136 hit the primary parabolic trough 122 substantially perpendicularly. When the double parabolic trough mirror system 120 is placed in a south-north position, the primary parabolic trough 122 will follow with sun from east to west. A mechanical lift mechanism 142 may also lift one side the entire double parabolic trough mirror system 120 at different angles to be raised up and down facing south to adjust the sun height seasonally.

With the single rod 103a as an example, the single rod 103a has a top end 130, a side face 131, and a bottom end 132. An exemplary sun ray 136a is received at a top end 130 of the single rod 103a; emitted and degraded along the side face 131 the single rod 103a; and then emitted through the bottom end 132 of the single rod 103a. A bright area 133 formed by light is emitted along and surrounds the single rod 103a. If the rods 103 are placed within 5 to 6 inches of each other, dark volume, which would have existed in the container 102 without the diffused acrylic rods 103 because of the algae suspension 108, would disappear. Such coverage also allows light to reach deeper in the container 102.

Importantly, the rods 103 must be internally diffused in order to emit light along with the side face 131 of the rods 103. White pigment type of diffuser should be used in the rods 103. The proportion of the diffuser impacts the side light emission and the length of the rods 103 that can be used. The following is the equation to calculation the amount of diffuser necessary for a specific side light emission density and energy as well as length of the rods 103.

Equation of diffusion for acrylic rod:

Ps*As+Pb*Ab=Pt*Ab

Ps*As+Pt*Ab*α=Pt*Ab

α=(Pt*Ab−Ps*As)/(Pt*Ab)=(Pt*π*(d/2)²−Ps*π*d*L)/(Pt*π*(d/2)²)

As—total area of side of acrylic rod (in²)

Ab—total area of bottom of acrylic rod (in²)

α: percentage of diffuser in acrylic rod (%)

d—diameter of acrylic rod (in)

L—length of acrylic rod (in)

Ps—average light density and energy of along acrylic rod side (μmol m⁻² s⁻¹)

Pb—average light density and energy at bottom of acrylic rod (μmol m⁻² s⁻¹)=Pt*α

Pt—total incoming light density and energy (μmol m⁻² s⁻¹)

The diffuser can be any kind of white diffuser, such as Titanium Dioxide (TiO2). The white pigment is mixed in the rods 103, and for a single rod 103a as an example, the white pigment mixed in the single rod 103a redirects and reflects light to the side face 131 and illuminate the single rod 103a entirely instead of only at the bottom end 132 of the rod 103a. Different proportion of diffuser makes different light emission along the rod. More percentage of diffuser in the rod will reflect more light from the side and less from the bottom. The deeper the suspension, the longer the rods need to be and less proportion of diffuser is required to be mixed in the rod.

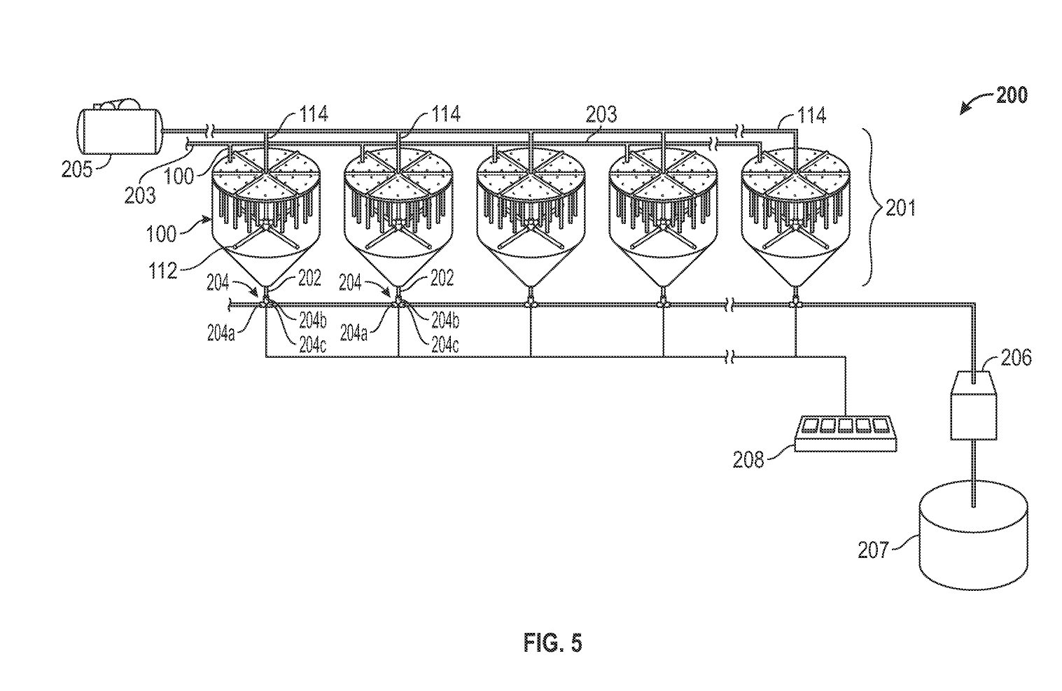

Referring to FIG. 5, a plurality of photobioreactor units 201 can be connected together to form a large-scale cultivation system 200 for algae production. In the preferred embodiment, the plurality of photobioreactor units 201 are connected by plastic pipes 202, such as PVC pipes and preferably 2 inches, with a three-way valve 204 at the bottom of each of the plurality of photobioreactor units 201 that allows the algae suspension 108 to leave each of the plurality of photobioreactor units 201 separately as to avoid cross contamination. The three-way valve 204 has a first valve 204a, top valve 204b, and second valve 204c wherein the top valve is connected to the plastic pipe 202 directly connected to the container 102. The three-way valve 204 has three main configurations: (a) a first configuration wherein the first valve 204a is closed, allowing fluids to flow through the top valve 204b and second valve 204c; (b) the second configuration wherein the top valve 204b is closed, allowing fluids to flow through the first valve 204a and second valve 204c; and (c) right valve 204c closed allowing fluids to flow through the top valve 204b and first valve 204a. The first configuration is used to release the algae suspension 108 into the plastic pipe 202 and the second configuration is used to push algae suspension 108 via a water pump 206 to a harvest central 207, for example.

In the preferred embodiment, the plurality of photobioreactor units 201 and the main plastic pipes 114 connecting them share a compressor 205 and pump to save the energy and cost. The productivity and throughput will be determined by the size of the photobioreactor unit 100 and size of the plurality of photobioreactor units 201 connected together. Furthermore, any sensors 107 (FIG. 1) and a controller system 208 can be also added and shared with multiple photobioreactor units 201 to form an automatic production system. In other embodiments, algae seeding and nutrients can be pumped into tank through a series of plastic pipes 203 that attaches to each hole 101 (FIG. 1) on each removable circular top 104 (FIG. 1).

Because the algae-cycling system 112 is an air-driven algae suspension circulation system within a self-contained container 102, each of the plurality photobioreactor units 201 may have a totally isolated environment for algae cultivation. Along with the algae-cycling system 112, the three-way valves 204 allow the plurality of photobioreactor units 201 to both harvest and drain the algae suspension 108 separately and thus preventing cross-contamination. For example, if an exemplary photobioreactor unit 100 is contaminated, its being contaminated does not contaminate the rest of the plurality of photobioreactors 201 and it also can be drained without affecting the rest of the plurality of photobioreactor units 201.

The components, steps, features, objects, benefits and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits and advantages. These also include embodiments in which the components and/or steps are arranged and/or ordered differently.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases in a claim mean that the claim is not intended to and should not be interpreted to be limited to any of the corresponding structures, materials, or acts or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

The terms and expressions used herein have the ordinary meaning accorded to such terms and expressions in their respective areas, except where specific meanings have been set forth. Relational terms such as first and second and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element proceeded by “a” or “an” does not, without further constraints, preclude the existence of additional elements of the identical type.

The Abstract is provided to help the reader quickly ascertain the nature of the technical disclosure. It is submitted with the understanding that it will not be used to interpret or limit the scope or meaning of the claims. In addition, various features in the foregoing Detailed Description are grouped together in various embodiments to streamline the disclosure. This method of disclosure is not to be interpreted as requiring that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as separately claimed subject matter.

The invention claimed is:

1. A large-scale cultivation system for growing algae, comprising
one or more photobioreactor units, each of which comprising
a container for containing an algae suspension, wherein the container has a circular opening, is cylindrical along a vertical central axis, and has a conical bottom closing the cylinder;
a removable clear circular top with a top side and a bottom side;
an array of diffused acrylic rods that are perpendicularly mounted to the bottom side of the removable clear circular top, wherein each of the array of diffused acrylic rods is about 5 to 6 inches apart;
clear support bars across the top side of the removable clear circular top to support the array of diffused acrylic rods; and
an algae-cycling system comprising
a compressor to provide pressure air into a main plastic pipe;
the main plastic pipe, which connects to the removable clear circular top, is then housed along the vertical center axis of the container;
two or more branch plastic pipes connecting perpendicularly to the main plastic pipe and horizontally housed in the container, wherein the two or more branch plastic pipes are seated generally at the edge of the conical bottom of the container; and
all of the two or more branch plastic pipes each have a top side and a bottom side, wherein on the bottom side of the two or more branch plastic pipes are a plurality of holes for pressure air to enter into the container and vertically drive the circulation of the algae suspension within the entire container due to the shape of the conical bottom
one or more double parabolic trough mirror systems used to collect sunlight, and each comprising
a primary parabolic trough with a vertex line and a reflective side that faces its parabolic focal line, wherein the reflective side of the primary parabolic trough is facing primarily upward towards the sun;
a secondary parabolic trough with a reflective side that also faces the parabolic focal line of the primary parabolic trough, wherein, in relation to the primary parabolic trough, the secondary parabolic trough is held in place farther than the focal line of the primary parabolic trough by mounting racks such that all sun rays hitting the primary parabolic trough would be reflected onto the secondary parabolic trough;
a slit at the vertex line of the primary parabolic trough that is less than the dimensions of the secondary parabolic trough;
an optic filter that is adjacent right below the secondary parabolic trough and only allows wavelengths between 400 nm to 750 nm to be passed through;
a series of fiber optic cables sit below the slit of the primary parabolic trough, wherein each of the series of fiber optic cables is attached to each of the array of diffused acrylic rods of the photobioreactor unit respectively with a one-to-one ratio, such that one double parabolic trough system is connected to at least one photobioreactor;
a series of lenses that sit on top of the series of fiber optic cables respectively in a one-to-one ratio, in a holder and convert a focused light into parallel light in order to reduce light loss;
a base that holds the entire double parabolic trough mirror system; and
a sunlight tracking system and a motor controlled by the sunlight tracking system that follows the sun's movement and steers the double parabolic trough mirror system in the direction of the sun, such that sun rays hit the primary parabolic trough substantially perpendicularly.

2. A large-scale cultivation system of claim 1, further comprising a hole on the removable clear circular top for which algae seeding and nutrients can be pumped into the container.

3. A large-scale cultivation system of claim 1, further comprising sensors for monitoring algae cultivation that are mounted on the removable circular top to provide algae growth data.

4. A large-scale cultivation system of claim 1, wherein each of the series of fiber optic cables has a core diameter of approximately 19 mm and each of the series of lenses convert the focused light into a 19 mm parallel light.

5. A large-scale cultivation system of claim 1, wherein the containers are 90 inches in diameter and 45 or 70 inches in height.

6. A large-scale cultivation system of claim 4, further consisting
8 evenly spaced rods along an imaginary first circle having a diameter of 18 inches, sharing the same center as the container;
8 evenly spaced rods along an imaginary second circle having a diameter of 30 inches, sharing the same center as the container;
8 evenly spaced rods along an imaginary third circle having a diameter of 42 inches, sharing the same center as the container;
16 evenly spaced rods along an imaginary fourth circle having a diameter of 54 inches, sharing the same center as the container;
24 evenly spaced rods along an imaginary fifth circle having a diameter of 66 inches, sharing the same center as the container; and
24 evenly spaced rods along an imaginary sixth circle having a diameter of 80 inches, sharing the same center as the container

7. A method for providing light to an algae suspension comprising the steps of
providing a large-scale algae cultivation system comprising
one or more photobioreactor units, each of which comprising
a container for containing an algae suspension, wherein the container has a circular opening, is cylindrical along a vertical central axis, and has a conical bottom closing the cylinder;
a removable clear circular top with a top side and a bottom side;
an array of diffused acrylic rods that are perpendicularly mounted to the bottom side of the removable clear circular top, wherein each of the array of diffused acrylic rods is about 5 to 6 inches apart;
clear support bars across the top side of the removable clear circular top to support the array of diffused acrylic rods; and
an algae-cycling system comprising
a compressor to provide pressure air into a main plastic pipe;
the main plastic pipe, which connects to the removable clear circular top, is then housed along the vertical center axis of the container;
two or more branch plastic pipes connecting perpendicularly to the main plastic pipe and horizontally housed in the container, wherein the two or more branch plastic pipes are seated generally at the edge of the conical bottom of the container; and
all of the two or more branch plastic pipes each have a top side and a bottom side, wherein on the bottom side of the two or more branch plastic pipes are a plurality of holes for pressure air to enter into the container and vertically drive the circulation of the algae suspension within the entire container due to the shape of the conical bottom
one or more double parabolic trough mirror systems used to collect sunlight, and each comprising
a primary parabolic trough with a vertex line and a reflective side that faces its parabolic focal line, wherein the reflective side of the primary parabolic trough is facing primarily upward towards the sun;
a secondary parabolic trough with a reflective side that also faces the parabolic focal line of the primary parabolic trough, wherein, in relation to the primary parabolic trough, the secondary parabolic trough is held in place farther than the focal line of the primary parabolic trough by mounting racks such that all sun rays hitting the primary parabolic trough would be reflected onto the secondary parabolic trough;
a slit at the vertex line of the primary parabolic trough that is less than the dimensions of the secondary parabolic trough;
an optic filter that is adjacent right below the secondary parabolic trough and only allows wavelengths between 400 nm to 750 nm to be passed through;
a series of fiber optic cables sit below the slit of the primary parabolic trough, wherein each of the series of fiber optic cables is attached to each of the array of diffused acrylic rods of the photobioreactor unit respectively with a one-to-one ratio, such that one double parabolic trough system is connected to at least one photobioreactor;
a series of lenses that sit on top of the series of fiber optic cables respectively in a one-to-one ratio, in a holder and convert a focused light into parallel light in order to reduce light loss;
a base that holds the entire double parabolic trough mirror system; and
a sunlight tracking system and a motor controlled by the sunlight tracking system that follows the sun's movement and steers the double parabolic trough mirror system in the direction of the sun, such that sun rays hit the primary parabolic trough substantially perpendicularly;
introducing the algae suspension to the large-scale algae cultivation system;
programming the sunlight tracker system, which would be place in a south-north position, to follow the sun from east to west such that sun rays would hit the primary parabolic trough substantially perpendicularly; and
turning, manually or automatically, the three-way valve to allow the algae suspension to leave the container to reach a harvest central or waste disposal.

8. A method for providing light to an algae suspension of claim 7, further providing a hole on the removable clear circular top for which algae seeding and nutrients can be pumped into the container.

9. A method for providing light to an algae suspension of claim 7, further providing sensors for monitoring algae cultivation that are mounted on the removable circular top to provide algae growth data.

10. A method for providing light to an algae suspension of claim 7, wherein each of the series of fiber optic cables has a core diameter of approximately 19 mm and each of the series of lenses converts the focused light into a 19 mm parallel light.

11. A method for providing light to an algae suspension of claim 7, further providing containers that are 90 inches in diameter and 45 or 70 inches in height.

12. A method for providing light to an algae suspension of claim 10, further providing
8 evenly spaced diffused acrylic rods along an imaginary first circle having a diameter of 18 inches, sharing the same center as the container;
8 evenly spaced diffused acrylic rods along an imaginary second circle having a diameter of 30 inches, sharing the same center as the container;
8 evenly spaced diffused acrylic rods along an imaginary third circle having a diameter of 42 inches, sharing the same center as the container;
16 evenly spaced diffused acrylic rods along an imaginary fourth circle having a diameter of 54 inches, sharing the same center as the container;
24 evenly spaced diffused acrylic rods along an imaginary fifth circle having a diameter of 66 inches, sharing the same center as the container; and
24 evenly spaced diffused acrylic rods along an imaginary sixth circle having a diameter of 80 inches, sharing the same center as the container

13. A double parabolic trough mirror systems used to collect sunlight, and each comprising
a primary parabolic trough with a vertex line and a reflective side that faces its parabolic focal line, wherein the reflective side of the primary parabolic trough is facing primarily upward towards the sun;
a secondary parabolic trough with a reflective side that also faces the parabolic focal line of the primary parabolic trough, wherein, in relation to the primary parabolic trough, the secondary parabolic trough is held in place farther than the focal line of the primary parabolic trough by supporters such that all sun rays hitting the primary parabolic trough would be reflected onto the secondary parabolic trough;
a slit at the vertex line of the primary parabolic trough that is less than the dimensions of the secondary parabolic trough;
an optic filter that is adjacent right below the secondary parabolic trough and only allows wavelengths between 400 nm to 750 nm to be passed;
a series of fiber optic cables sit below the slit of the primary parabolic trough, wherein each of the series of fiberoptic cables has a core diameter of approximately 19 mm;
a series of lenses that sit on top of the series of fiber optic cables respectively in a one-to-one ratio, in a holder and converts a focused light into a 19 mm parallel light in order to reduce light loss;
a base that holds the entire double parabolic trough mirror system; and
a sunlight tracking system and a motor controlled by the sunlight tracking system that follows the sun's movement and steers the double parabolic trough mirror system in the director of the sun, such that sun rays hit the primary parabolic trough substantially perpendicularly.
